(19) United States
(12) Patent Application Publication
(10) Pub. No.: US 2026/0126713 A1
(43) Pub. Date: May 7, 2026

(54) LIGHT SOURCE DEVICE AND PROJECTOR

(71) Applicant: SEIKO EPSON CORPORATION, Tokyo (JP)

(72) Inventor: Namiko ONOTA, MATSUMOTO-SHI (JP)

(21) Appl. No.: 19/379,220

(22) Filed: Nov. 4, 2025

(30) Foreign Application Priority Data
Nov. 5, 2024 (JP) 2024-193458

(51) Int. Cl. G03B 21/20

(52) U.S. Cl. CPC G03B 21/204; G03B 21/2066

(57) ABSTRACT

A light source device according to the present disclosure includes a light source section that emits first light in a first wavelength band; a wavelength conversion layer configured to convert the first light into second light in a second wavelength band; and a translucent substrate having a first face and a second face, the wavelength conversion layer being provided on the first face. The first light emitted from the light source section enters the translucent substrate from the second face, passes through the translucent substrate, and enters the wavelength conversion layer from the first face. A part of the second light converted by the wavelength conversion layer enters the translucent substrate from the first face. The light source device includes a first reflective surface that intersects the first face and the second face of the translucent substrate and reflects the second light.

The present application is based on, and claims priority from JP Application Serial Number 2024-193458, filed November 5, 2024, the disclosure of which is hereby incorporated by reference herein in its entirety.

### BACKGROUND

### 1. Technical Field

The present disclosure relates to a light source device and a projector.

### 2. Related Art

As a light source device used in a projector, a light source device has been proposed that uses fluorescence emitted when a phosphor is irradiated with excitation light emitted from a light emitting element. JP-A-2012-3923 discloses a light source device that causes excitation light to enter a phosphor layer formed on a transparent substrate and generates illumination light including fluorescence and a part of the excitation light. In the light source device, the excitation light emitted from the excitation light source is sequentially transmitted through the transparent substrate and the dichroic layer, and then enters the phosphor layer.

Among the fluorescence emitted in all directions from the phosphor layer, the fluorescence that travels toward the transparent substrate is reflected by the dichroic layer and extracted from the side opposite to the transparent substrate.

In the light source device described in JP-A-2012-3923, in order to extract the fluorescence in a desired direction, that is, from the side opposite to the transparent substrate, a dichroic layer that transmits the excitation light and reflects the fluorescence is provided between the transparent substrate and the phosphor layer. However, due to the optical characteristics of the dichroic layer, the fluorescence incident on the dichroic layer is transmitted through the dichroic layer and leaks into the transparent substrate. The fluorescence leaking into the transparent substrate may propagate through the transparent substrate while undergoing total internal reflection, and there is a possibility that fluorescence may be emitted out from the side surface of the transparent substrate. This fluorescence is difficult to use as illumination light, and there is a problem that the use efficiency of the fluorescence is reduced.

### SUMMARY

In order to solve the above problems, a light source device according to an aspect of the present disclosure includes a light source section that emits first light in a first wavelength band; a wavelength conversion layer that converts the first light into second light in a second wavelength band different from the first wavelength band; and a translucent substrate including a first face, a second face opposite to the first face, and the wavelength conversion layer that is arranged on the first face. The first light emitted from the light source section enters the translucent substrate through the second face, passes through the translucent substrate, and reaches the wavelength conversion layer on the first face. subsequently, a part of the second light converted by the wavelength conversion layer is emitted toward the translucent substrate through the first face. The light source device includes a first reflective surface that intersects the first face and the second face of the translucent substrate and reflects the second light.

A projector according to another aspect of the disclosure includes the illuminator according to the aspect of the disclosure, a light modulator that modulates light outputted from the illuminator in accordance with image information, and a projection optical device that projects light modulated by the light modulation device.

### BRIEF DESCRIPTION OF THE DRAWINGS

FIG. 1 is schematic configuration diagram of a projector according to a first embodiment.

FIG. 2 is schematic configuration diagram of the light source device according to the first embodiment.

FIG. 3 is a front view of the wavelength conversion device.

FIG. 4 is a cross-sectional view of the wavelength conversion section taken along line IV-IV in FIG. 3.

FIG. 5 is a diagram illustrating a problem of a light source device in the related art.

FIG. 6 is a cross-sectional view of a wavelength conversion section in a light source device according to a second embodiment.

FIG. 7 is a cross-sectional view of a wavelength conversion section in a light source device according to a third embodiment.

### DESCRIPTION OF EMBODIMENTS

### FIRST EMBODIMENT

Hereinafter, a first embodiment of the present disclosure will be described with reference to the drawings.

In the drawings used in the following description, in order to make features easy to understand, characteristic portions may be enlarged for convenience, and the dimensional ratio of each component may be changed as appropriate.

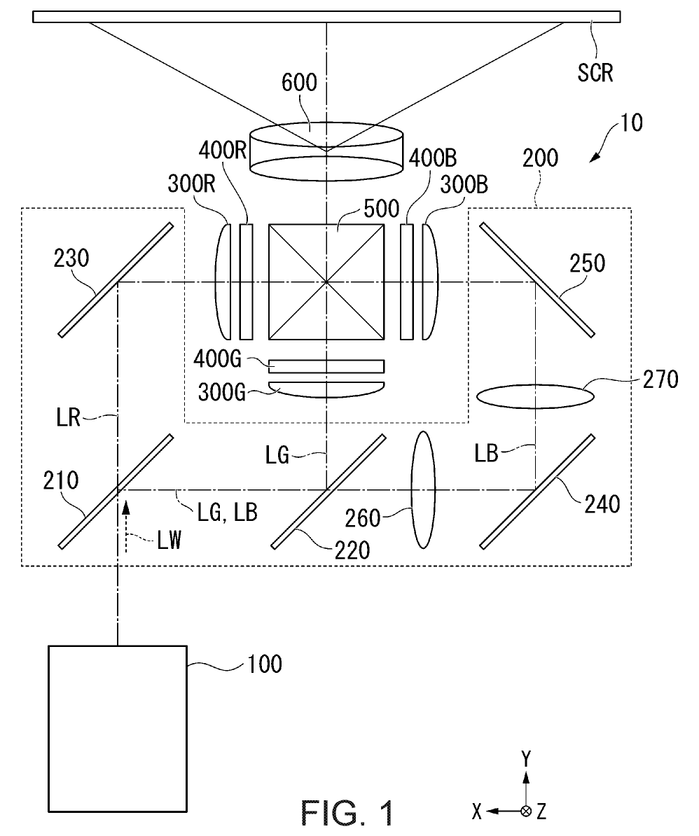

FIG. 1 is schematic configuration diagram of a projector according to the present embodiment.

As shown in FIG. 1, a projector 10 of the present embodiment is a projection-type image display device that displays an image on a screen SCR. The projector 10 includes a light source device 100, a color separation optical system 200, a light modulation device 400R, a light modulation device 400G, a light modulation device 400B, a combining optical system 500, and a projection optical device 600. In the following description, an axis along the left-right direction of the projector is defined as an X-axis, an axis along the front-rear direction of the projector is defined as a Y-axis, and an axis along the vertical direction of the projector and perpendicular to the X-axis and the Y-axis is defined as a Z-axis.

The light source device 100 emits white illumination light LW toward the color separation optical system 200. The configuration of the light source device 100 will be described in detail later.

The color separation optical system 200 separates the illumination light LW outputted from the light source device 100 into red light LR, green light LG, and blue light LB. The color separation optical system 200 includes a first dichroic mirror 210, a second dichroic mirror 220, a first reflective mirror 230, a second reflective mirror 240, a third reflective mirror 250, a first relay lens 260, and a second relay lens 270.

The first dichroic mirror 210 transmits the red light LR and reflects the light including the green light LG and the blue light LB. The first dichroic mirror 210 thus separates the illumination light LW outputted from the light source device 100 into the red light LR and light containing the green light LG and the blue light LB. The second dichroic mirror 220 reflects the green light LG and transmits the blue light LB. The second dichroic mirror 220 thus separates the light containing the green light LG and the blue light LB outputted from the first dichroic mirror 210 into the green light LG and the blue light LB.

The first reflective mirror 230 is arranged in the optical path of the red color light LR, and reflects the red color light LR transmitted through the first dichroic mirror 210 toward the light modulation device 400R. The second reflective mirror 240 and the third reflective mirror 250 are arranged in the optical path of the blue light LB and guide the blue light LB having passed through the second dichroic mirror 220 toward the light modulation device 400B. The green light LG is reflected off the second dichroic mirror 220 toward the light modulation device 400G.

The first relay lens 260 is arranged between the second dichroic mirror 220 and the second reflective mirror 240 in the optical path of the blue light LB. The second relay lens 270 is arranged between the second reflective mirror 240 and the third reflective mirror 250 in the optical path of the blue light LB. The first relay lens 260 and the second relay lens 270 compensate for the light loss of the blue light LB caused by the fact that the optical path length of the blue light LB is longer than the optical path length of the red light LR or the green light LG.

The light modulation device 400R modulates the red color light LR in accordance with image information to form image light corresponding to the red color light LR. The light modulation device 400G modulates the green light LG in accordance with image information to form image light corresponding to the green light LG. The light modulation device 400B modulates the blue light LB in accordance with image information to form image light corresponding to the blue light LB. Transmissive-type liquid crystal panels, for example, are used as the light modulation devices 400R, 400G, and 400B. Further, a polarizer (not shown) is arranged on each of the incident side and the emission side of each liquid crystal panel.

A field lens 300R is arranged on the incident side of the light modulation device 400R. The field lens 300R parallelizes the red color light LR incident on the light modulation device 400R. A field lens 300G is arranged on the incident side of the light modulation device 400G. The field lens 300G parallelizes the green light LG incident on the light modulation device 400G. A field lens 300B is arranged on the incident side of the light modulation device 400B. The field lens 300B parallelizes the blue light LB incident on the light modulation device 400B.

Image light emitted from the light modulation devices 400R, 400G, and 400B enters the combining optical system 500. The combining optical system 500 combines the image light corresponding to the red light LR, the image light corresponding to the green light LG, and the image light corresponding to the blue light LB with one another, and outputs the combined image light toward the projection optical device 600. The combining optical system 500 includes, for example, a cross dichroic prism.

The projection optical device 600 includes a plurality of projection lenses. The projection optical device 600 enlarges and projects the image light combined by the combining optical system 500 toward the screen SCR. Thus, an enlarged image is displayed on the screen SCR.

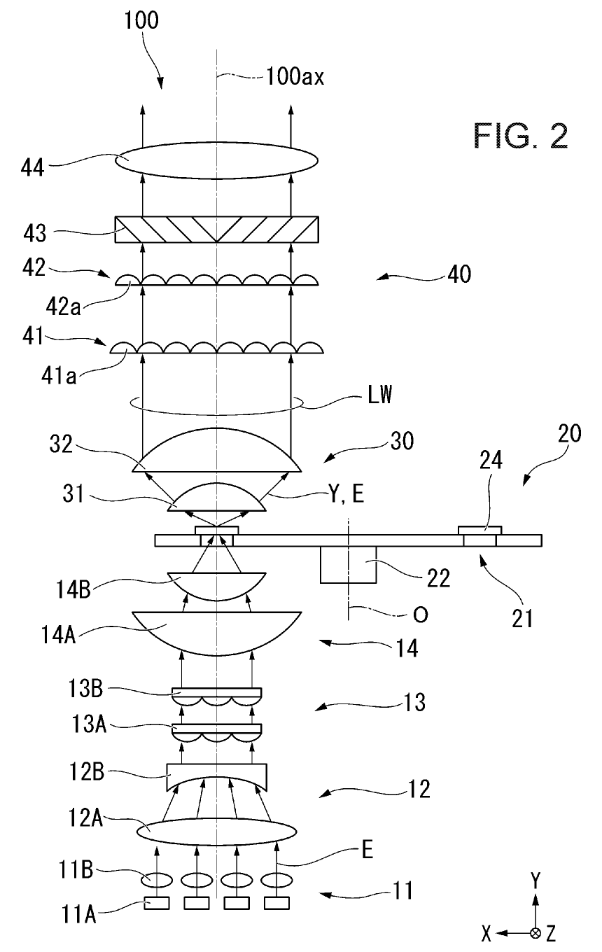

Hereinafter, the configuration of the light source device 100 will be described with reference to FIG. 2.

FIG. 2 is schematic configuration diagram illustrating the light source device 100 of the present embodiment.

The light source device 100 includes a light source section 11, an afocal optical system 12, a homogenizer optical system 13, a condensing optical system 14, a wavelength conversion device 20, a pickup optical system 30, and a uniform lighting optical system 40, as shown in FIG. 2.

The light source section 11 is configured of a plurality of laser diodes 11A and a plurality of collimator lenses 11B. The plurality of laser diodes 11A each emit the excitation light E in the blue wavelength band formed of laser light. The plurality of laser diodes 11A are arranged in an array in a plane perpendicular to an illumination optical axis 100ax. The illumination optical axes 100ax are defined as optical axes parallel to the Y-axis and as the central axes of light fluxes including a plurality of beams of the excitation light E emitted from the plurality of laser diodes 11A. The excitation light E in the present embodiment corresponds to the first light in the appended claims.

Collimator lenses 11B are arranged in an array in a plane perpendicular to the illumination optical axis 100ax, corresponding to the respective laser diode 11A. The collimator lens 11B converts the excitation light E emitted at a predetermined divergence angle from the laser diode 11A corresponding to the collimator lens 11B into parallel light. The number of the laser diodes 11A and the number of the collimator lenses 11B constituting the light source section 11 are not particularly limited, and may be one each.

The afocal optical system 12 includes a convex lens 12A and a concave lens 12B. The afocal optical system 12 reduces the light flux diameter of the excitation light E formed of a parallel light flux emitted from the light source section 11. As the afocal optical system 12, a light flux width reduction optical system in which, for example, a polarization separation mirror, a total reflective mirror, and the like are combined may be used instead of the configuration including the two lenses described above.

The homogenizer optical system 13 includes a first multi-lens array 13A and a second multi-lens array 13B. The homogenizer optical system 13 converts the intensity distribution of the excitation light E into a uniform distribution, what is called a top-hat distribution, on a wavelength conversion layer 24 of the wavelength conversion device 20. The homogenizer optical system 13 superimposes the plurality of small light beams emitted from the plurality of lenses of the first multi-lens array 13A and the second multi-lens array 13B on each other on the wavelength conversion layer 24 of the wavelength conversion device 20, together with the condensing optical system 14. The intensity distribution of the excitation light E with which the wavelength conversion layer 24 is irradiated is thereby made uniform.

The condensing optical system 14 includes a first lens 14A and a second lens 14B. The number of lenses constituting the condensing optical system 14 is not particularly limited. Each of the first lens 14A and the second lens 14B is formed of a convex lens. The condensing optical system 14 is arranged in the optical path of the excitation light E between the homogenizer optical system 13 and the wavelength conversion device 20. The condensing optical system 14 collects the excitation light E and causes the collected excitation light E to be incident on the wavelength conversion layer 24 of the wavelength conversion device 20.

Next, a configuration of the wavelength conversion device 20 will be described.

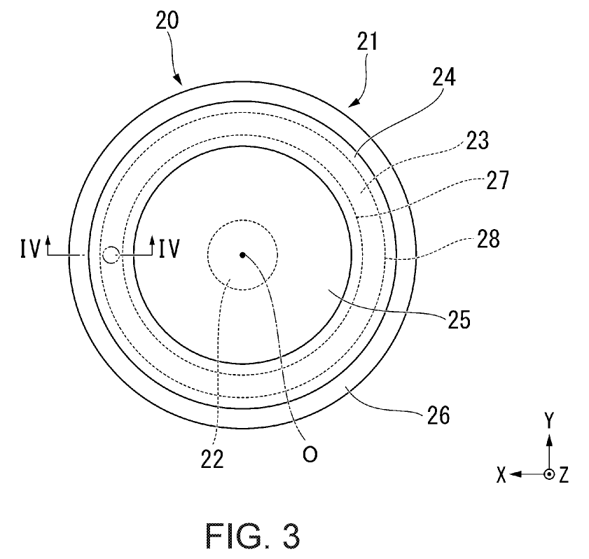

FIG. 3 is a front view of the wavelength conversion device 20.

As shown in FIG. 3, the wavelength conversion device 20 of the present embodiment includes a wavelength conversion section 21 and a rotary drive section 22. The wavelength conversion section 21 is a disc-shaped component and converts the excitation light E outputted from the light source section 11 into the fluorescence Y. The rotary drive section 22 is formed of a motor that rotates the wavelength conversion section 21 around the rotation axis O. In the following description, a direction orthogonal to the rotation axis O is referred to as a radial direction, a side of the radial direction approaching the rotation axis O is referred to as a radially inner side, and a side of the radial direction away from the rotation axis O is referred to as a radially outer side.

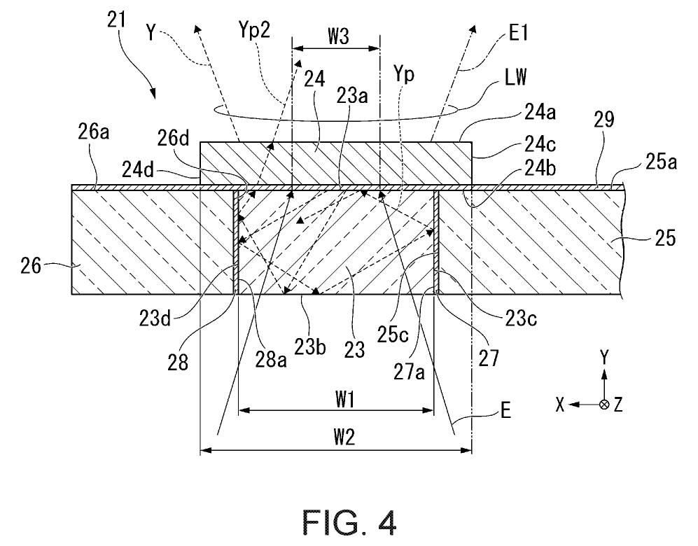

FIG. 4 is a cross-sectional view of the wavelength conversion section 21 taken along line IV-IV in FIG. 3.

As shown in FIG. 4, the wavelength conversion section 21 includes a translucent substrate 23, the wavelength conversion layer 24, a first support substrate 25, a second support substrate 26, a first reflective layer 27, a second reflective layer 28, and a dichroic layer 29.

The translucent substrate 23 is formed of an annular plate material made of, for example, a transparent yttrium aluminum garnet (YAG) crystal. The translucent substrate 23 has a first face 23a and a second face 23b on the opposite side from the first face 23a. In the case of the present embodiment, of the two faces of the translucent substrate 23, the face on the side facing the pickup optical system 30 shown in FIG. 2 is defined as the first face 23a, and the surface on the side facing the condensing optical system 14 is defined as the second face 23b. The wavelength conversion layer 24 is arranged on the first face 23a. Of two side faces intersecting the first face 23a and the second face 23b of the translucent substrate 23, a side surface located on the inner side in the radial direction is referred to as a first side 23c, and a side surface located on the outer side in the radial direction is referred to as a second side 23d.

The material of the translucent substrate 23 is not particularly limited to transparent YAG as long as the material has a light-transmissive property, and for example, silicon carbide, sapphire, alumina, glass, or the like may be used. It is desirable that a material having a high thermal conductivity is used as the material of the translucent substrate 23. When transparent YAG is used as the material of the translucent substrate 23, the thermal conductivity of the translucent substrate 23 is higher than that of, for example, a glass material, and therefore, the heat of the wavelength conversion layer 24 is easily transferred to the translucent substrate 23, and the heat dissipation of the wavelength conversion layer 24 can be enhanced. The transparent YAG is a material obtained by removing the cerium activator from the YAG (YAG: Ce) constituting the wavelength conversion layer 24.

The wavelength conversion layer 24 converts the excitation light E that passed through the translucent substrate 23 and that was incident on it into the fluorescence Y having the yellow wavelength band, which is different from the blue wavelength band. The wavelength conversion layer 24 of the present embodiment is formed in an annular shape on the first face 23a of the annular translucent substrate 23. In other words, as shown in FIG. 3, the wavelength conversion layer 24 is provided in an annular shape around the rotation axis O. Of the two surfaces of the wavelength conversion layer 24, the surface on the side facing the pickup optical system 30 shown in FIG. 2 is defined as a first face 24a, and the surface on the side facing the translucent substrate 23 is defined as a second face 24b. The fluorescence Y in the present embodiment corresponds to the second light in the appended claims.

The wavelength conversion layer 24 generates heat in accordance with the emission of the fluorescence Y. When the temperature of the wavelength conversion layer 24 exceeds a predetermined temperature, there is a risk that the wavelength conversion efficiency may be significantly reduced, and the amount of the emitted fluorescence Y may be reduced.

In the wavelength conversion device 20 according to the present embodiment, the wavelength conversion layer 24 rotates together with the translucent substrate 23, and therefore the position where the excitation light E is incident on the wavelength conversion layer 24 moves with time. This allows the wavelength conversion layer 24 to be easily cooled, and thus, a decrease in the wavelength conversion efficiency due to an increase in the temperature of the wavelength conversion layer 24 can be suppressed.

The wavelength conversion layer 24 allows the excitation light E to enter through the second face 24b, which faces the translucent substrate 23, and allows the fluorescence Y to exit through the first face 24a. The wavelength conversion device 20 according to the present embodiment is therefore a transmissive wavelength conversion device that outputs the illumination light LW containing the fluorescence Y via the first face 24a of the wavelength conversion layer 24, which is the surface opposite from the second face 24b through which the excitation light E enters.

The wavelength conversion layer 24 is formed of a wavelength conversion material containing a ceramic phosphor formed of a polycrystalline phosphor. The fluorescence Y has a yellow wavelength band of, for example, 490 to 750 nm. That is, the fluorescence Y is yellow fluorescence containing a red light component and a green light component. The wavelength conversion layer 24 may contain a single crystal phosphor instead of the polycrystalline phosphor. Alternatively, the wavelength conversion layer 24 may be formed of a material in which a large number of phosphor particles are dispersed in a binder formed of glass or resin.

Specifically, the material of the wavelength conversion layer 24 in the present embodiment contains, for example, an yttrium aluminum garnet (YAG) - based phosphor. In the case of YAG: Ce containing Cerium (Ce) as an activator, examples of the material of the wavelength conversion layer 24 include materials obtained by mixing and solid-phase reacting raw powders containing constituent elements such as Y₂O₃, Al₂O₃, and CeO₃, Y-Al-O amorphous particles obtained by a wet method such as a coprecipitation method or a sol gel method, and YAG particles obtained by a vapor phase method such as a spray drying method, a flame pyrolysis method, or a thermal plasma method.

The first support substrate 25 is formed of a disc-shaped plate material made of, for example, a transparent YAG crystal.

The outer diameter of the first support substrate 25 is smaller than the inner diameter of the translucent substrate 23. Therefore, the first support substrate 25 is arranged on the inner side of the translucent substrate 23 in the radial direction, and is bonded to the first side 23c of the translucent substrate 23 with an adhesive or the like. The material of the first support substrate 25 is not particularly limited to transparent YAG, and for example, silicon carbide, sapphire, alumina, glass, or the like may be used. It is desirable that a material having a high thermal conductivity is used as the material of the first support substrate 25.

The second support substrate 26 is formed of an annular plate material made of, for example, a transparent YAG crystal.

The inner diameter of the second support substrate 26 is larger than the outer diameter of the translucent substrate 23. Therefore, the second support substrate 26 is arranged on the outer side of the translucent substrate 23 in the radial direction, and is bonded to the second side 23d of the translucent substrate 23 with an adhesive or the like. The material of the second support substrate 26 is not particularly limited to transparent YAG, and for example, silicon carbide, sapphire, alumina, glass, or the like may be used. It is desirable that a material having high thermal conductivity is used as the material of the second support substrate 26.

In the present embodiment, the radial width W1 of the translucent substrate 23 is smaller than the radial width W2 of the wavelength conversion layer 24. In other words, the end section of the wavelength conversion layer 24 in the radial direction protrudes beyond the outside of the translucent substrate 23. Therefore, among the second face 24b of the wavelength conversion layer 24, the central section is in contact with the translucent substrate 23 via a dichroic layer 9, the radially inner end is in contact with the first support substrate 25 via the dichroic layer 9, and the radially outer end section is in contact with the second support substrate 26 via the dichroic layer 9. In this configuration, since the translucent substrate 23, the first support substrate 25, and the second support substrate 26 are all formed of a YAG-based material, the thermal conductivity is higher than that of a general glass material. The heat of the wavelength conversion layer 24 thus easily transfers not only to the translucent substrate 23 but also to the first support substrate 25 and the second support substrate 26, whereby the heat dissipation of the wavelength conversion layer 24 can be further enhanced.

The first reflective layer 27 is provided between the first side 23c of the translucent substrate 23 and a side face 25c of the first support substrate 25. The first reflective layer 27 is formed of, for example, a dielectric multilayer film, a metal film having a high reflectance such as silver or aluminum, an adhesive having a high reflectance, or the like. Thereby, the first reflective layer 27 having excellent reflectance can be formed. When the first reflective layer 27 is formed, the dielectric multilayer film, the metallic film, the adhesive, or the like may be formed on either the first side 23c of the translucent substrate 23 or the side face 25c of the first support substrate 25 before the translucent substrate 23 and the first support substrate 25 are bonded to each other. The face of the first reflective layer 27, which is opposed to the first side 23c of the translucent substrate 23, is a first reflective surface 27a, which reflects the fluorescence Y. The first reflective surface 27a is perpendicular to the first face 23a and the second face 23b of the translucent substrate 23.

The second reflective layer 28 is provided between the second side 23d of the translucent substrate 23 and a side face 26d of the second support substrate 26. The second reflective layer 28 is formed of, for example, a dielectric multilayer film, a metal film having a high reflectance such as silver or aluminum, an adhesive having a high reflectance, or the like, similarly to the first reflective layer 27. Thereby, the second reflective layer 28 having excellent reflectance can be formed. When the second reflective layer 28 is formed, the dielectric multilayer film, the metallic film, the adhesive, or the like described above may be formed on one of the second side 23d of the translucent substrate 23 and the side face 26d of the second support substrate 26 before the translucent substrate 23 and the second support substrate 26 are bonded to each other. The surface of the second reflective layer 28 facing the second side 23d of the translucent substrate 23 is a second reflective surface 28a that reflects the fluorescence. The second reflective surface 28a is perpendicular to the first face 23a and the second face 23b of the translucent substrate 23.

The dichroic layer 29 is provided between the first face 23a of the translucent substrate 23 and the second face 24b of the wavelength conversion layer 24. In the case of the present embodiment, the dichroic layer 29 is provided not only between the first face 23a of the translucent substrate 23 and the second face 24b of the wavelength conversion layer 24, but also over a first face 25a of the first support substrate 25 and a first face 26a of the second support substrate 26, but it is sufficient that the dichroic layer 29 is provided at least between the first face 23a of the translucent substrate 23 and the second face 24b of the wavelength conversion layer 24. The dichroic layer 29 transmits the excitation light E and reflects the fluorescence Y. The dichroic layer 29 is formed of, for example, a dielectric multilayer film.

The excitation light E emitted from the light source section 11 enters the translucent substrate 23 through the second face 23b of the translucent substrate 23, passes through the translucent substrate 23, and enters the wavelength conversion layer 24 through the second face 24b of the wavelength conversion layer 24. Therefore, an antireflection film for suppressing reflection of the excitation light E may be provided on the second face 23b of the translucent substrate 23. The antireflection film is formed of, for example, an AR coat. The efficiency of use of the excitation light E can therefore be increased. Since the excitation light E is focused by the condensing optical system 14, the width W3 of the irradiation region of the excitation light E on the wavelength conversion layer 24 is smaller than the width W2 of the wavelength conversion layer 24.

The thickness of the wavelength conversion layer 24 is set to such an extent that the wavelength of the excitation light E is not entirely converted when the excitation light E travels through the wavelength conversion layer 24. The wavelength conversion layer 24 causes the blue excitation light E1, which has not been wavelength-converted, to exit via the first face 24a in addition to the yellow fluorescence Y, which has been generated through the wavelength-conversion. The wavelength conversion device 20 thus outputs the white illumination light LW containing the excitation light E1 and the fluorescence Y through the first face 24a of the wavelength conversion layer 24 toward the condensing optical system 14.

Part of the fluorescence Y generated in the wavelength conversion layer 24 travels toward the second face 24b, that is, toward the translucent substrate 23 side, and enters the dichroic layer 29 provided on the first face 23a of the translucent substrate 23. Most of the fluorescence Y incident on the dichroic layer 29 is reflected toward the side opposite to the translucent substrate 23 and exits via the first face 24a of the wavelength conversion layer 24. On the other hand, since the fluorescence Y is unpolarized light, a part of the fluorescence Y that entered the dichroic layer 29 passes through the dichroic layer 29 due to the optical characteristics of the dichroic layer and enters the translucent substrate 23.

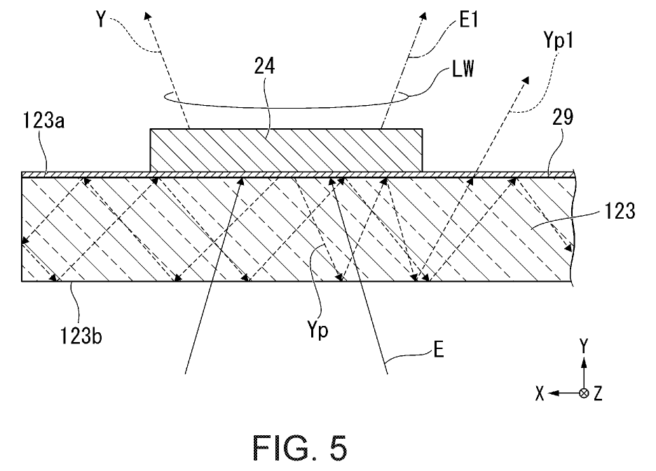

FIG. 5 is a diagram illustrating a problem of a light source device in the related art.

As shown in FIG. 5, in the light source device according to the related art, the fluorescence Y incident on a translucent substrate 123 from the wavelength conversion layer 24 via the dichroic layer 29 propagates through the translucent substrate 123 while being totally reflected off the translucent substrate 123. At this time, a part Yp1 of the fluorescence Yp propagating through the inside of the translucent substrate 123 may enter a first face 123a or a second face 123b of the translucent substrate 123 at an incident angle smaller than the critical angle, and leak to the outside. Such fluorescence is difficult to use as illumination light, and there is a concern that the use efficiency of fluorescence may decrease.

In contrast, in the light source device 100 according to the present embodiment, as shown in FIG. 4, the first reflective surface 27a and the second reflective surface 28a of the translucent substrate 23 orthogonal to the first face 23a and the second face 23b are provided. The fluorescence Y incident on the translucent substrate 23 via the dichroic layer 29 from the wavelength conversion layer 24 is therefore confined inside the translucent substrate 23 while being repeatedly reflected off the first reflective surface 27a and the second reflective surface 28a, whereby the propagation of the fluorescence Y toward the first support substrate 25 or the second support substrate 26 is suppressed. The fluorescence Y confined inside the translucent substrate 23 enters the wavelength conversion layer 24 again via the dichroic layer 29 while being repeatedly reflected, and is then emitted from the first face 24a of the wavelength conversion layer 24 as shown by the fluorescence Yp2. As described above, according to the light source device 100 related to the present embodiment, since the leakage of the fluorescence Y from the translucent substrate 23 is suppressed, it is possible to increase the utilization efficiency of the fluorescence Y compared to the related art.

According to a simulation by the inventor, it was confirmed that, in the case where the reflection surfaces were formed on the two side surfaces of the translucent substrate, the amount of fluorescence emitted from the first face of the wavelength conversion layer was increased by 10% or more under specific simulation conditions, compared with the case where no reflection surface was formed.

In the present embodiment, the radial width W1 of the translucent substrate 23 is smaller than the radial width W2 of the wavelength conversion layer 24, and therefore the first reflective layer 27 and the second reflective layer 28 are located to the inner side of the two side faces 24c and 24d of the wavelength conversion layer 24. In other words, the first reflective layer 27 and the second reflective layer 28 are arranged at positions overlapping the wavelength conversion layer 24 when viewed from a direction perpendicular to the first face 23a of the translucent substrate 23. Instead of this configuration, the first reflective layer 27 and the second reflective layer 28 may be located outside the two side faces 24c and 24d of the wavelength conversion layer 24. In other words, the first reflective layer 27 and the second reflective layer 28 may be arranged at positions not overlapping the wavelength conversion layer 24 when viewed from the direction perpendicular to the first face 23a of the translucent substrate 23. However, according to the configuration of the present embodiment, the fluorescence Yp confined in the translucent substrate 23 is likely to reenter the wavelength conversion layer 24, and leakage of the fluorescence Yp can be further reduced.

As shown in FIG. 2, the illumination light LW emitted from the wavelength conversion device 20 enters the pickup optical system 30. The pickup optical system 30 includes a first collimating lens 31 and a second collimating lens 32. The number of lenses constituting the pickup optical system 30 is not particularly limited. The pickup optical system 30 substantially parallelizes the illumination light LW outputted from the wavelength conversion device 20. Each of the first collimating lens 31 and the second collimating lens 32 is formed of a convex lens. The illumination light LW collimated by the pickup optical system 30 enters the uniform lighting optical system 40.

The uniform lighting optical system 40 includes a first lens array 41, a second lens array 42, a polarization conversion element 43, and a superimposing lens 44.

The first lens array 41 includes a plurality of first lenses 41a for dividing the illumination light LW from the light source device 100 into a plurality of partial light fluxes. The plurality of first lenses 41a is arranged in a matrix in a plane perpendicular to the illumination optical axis 100ax.

The second lens array 42 includes a plurality of second lenses 42a corresponding to the plurality of first lenses 41a of the first lens array 41. The plurality of second lenses 42a are arranged in a matrix in a plane perpendicular to the illumination optical axis 100ax. The second lens array 42 forms the images of the first lenses 41a of the first lens array 41 in the vicinities of the image formation regions of the light modulation devices 400R, 400G, and 400B, respectively, together with the superimposing lens 44.

The polarization conversion element 43 converts the illumination light LW emitted from the second lens array 42 into linearly polarized light having a predetermined polarization direction. The polarization conversion element 43 includes a polarization separation film and a phase contrast plate (not shown).

The superimposing lens 44 condenses partial light fluxes emitted from the polarization conversion element 43 and superimposes them in the vicinity of an image formation region of the light modulation device 400R, the light modulation device 400G, and the light modulation device 400B.

### Effects of first embodiment

The light source device 100 according to the present embodiment includes the light source section 11, which outputs the excitation light E, the wavelength conversion layer 24, which converts the excitation light E into the fluorescence Y, and the translucent substrate 23, which has the first face 23a and the second face 23b and to which the wavelength conversion layer 24 is provided on the first face 23a. The excitation light E emitted from the light source section 11 enters the translucent substrate 23 through the second face 23b, passes through the translucent substrate 23, and enters the wavelength conversion layer 24 through the first face 23a. A part Yp of the fluorescence Y converted by the wavelength conversion layer 24 enters the translucent substrate 23 through the first face 23a. The light source device 100 includes the first reflective surface 27a and a second reflective surface 28a, which intersect the first face 23a and the second face 23b of the translucent substrate 23 and reflect fluorescence Y.

As described above, in the light source device 100 according to the present embodiment, the part of the fluorescence Y that entered the translucent substrate 23 is confined inside the translucent substrate 23 by the first reflective surface 27a and the second reflective surface 28a, and then enters the wavelength conversion layer 24 again, and is emitted to the outside via the first face 24a of the wavelength conversion layer 24. The leakage of the fluorescence Y from the translucent substrate 23 is suppressed in the above manner, whereby the efficiency of use of the fluorescence Y can be increased as compared with the related art. As a result, the light source device 100 according to the present embodiment can increase the amount of fluorescence Y that can be used as the illumination light LW, whereby bright illumination light LW can be generated.

The projector 10 according to the present embodiment includes the light source device 100, the light modulation devices 400R, 400G, and 400B, which modulate the illumination light LW incident from the light source device 100, and the projection optical device 600, which projects the light modulated by the light modulation devices 400R, 400G, and 400B.

According to the projector 10 of the present embodiment, it is possible to project a bright image by modulating the bright illumination light LW entering the projector 10 from the light source device 100.

### SECOND EMBODIMENT

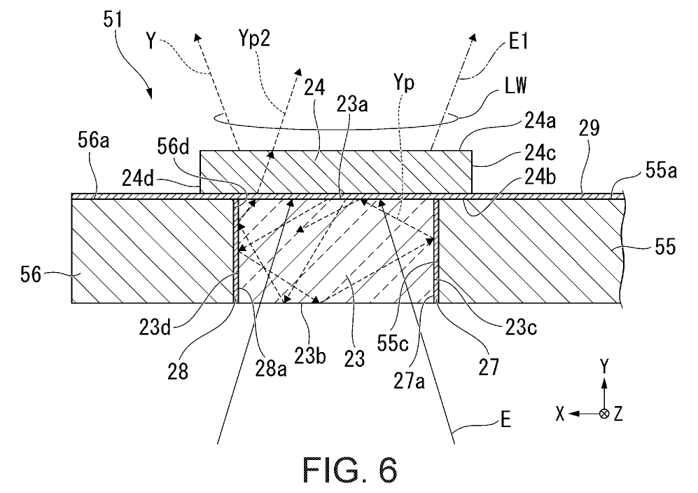

Hereinafter, a second embodiment of the present disclosure will be described with reference to FIG. 6.

The basic configurations of a projector and a light source device according to the second embodiment are substantially the same as those in the first embodiment, and the configuration of the wavelength conversion device is different from that in the first embodiment. Therefore, the description of the basic configuration of the projector and the light source device will be omitted.

FIG. 6 is a cross-sectional view of a wavelength conversion section 51 in a light source device according to a second embodiment.

In FIG. 6, the same reference numerals are given to the same components as those in FIG. 4 used in the first embodiment, and the description thereof will be omitted.

The wavelength conversion section 51 in the present embodiment is formed of the translucent substrate 23, the wavelength conversion layer 24, a first support substrate 55, a second support substrate 56, the first reflective layer 27, the second reflective layer 28, and the dichroic layer 29, as shown in FIG. 6.

In the wavelength conversion section 21 according to the first embodiment, the first support substrate 25 and the second support substrate 26 are each formed of a light-transmissive material such as transparent YAG. In contrast, in the wavelength conversion section 51 according to the present embodiment, each of the first support substrate 55 and the second support substrate 56 is made of a metal having high thermal conductivity, such as aluminum or copper. The dichroic layer 29 is provided between the first face 23a of the translucent substrate 23 and the second face 24b of the wavelength conversion layer 24, and across a first face 55a of the first support substrate 55 and a first face 56a of the second support substrate 56.

The first reflective layer 27 and the second reflective layer 28 each have the same configuration as in the first embodiment. In other words, the first reflective layer 27 is provided between the first side 23c of the translucent substrate 23 and a side face 55c of the first support substrate 55. The second reflective layer 28 is provided between the second side 23d of the translucent substrate 23 and a side face 56d of the second support substrate 56. The first reflective layer 27 and the second reflective layer 28 are formed of, for example, a dielectric multilayer film, a metal film having a high reflectance such as silver or aluminum, an adhesive having a high reflectance, or the like.

The other configurations of the light source device are substantially the same as those of the light source device according to the first embodiment.

In a case where the first support substrate 55 is made of a metal having a high reflectance such as aluminum, the first reflective layer 27 may not necessarily be provided. In this case, the side face 55c of the first support substrate 55 is preferably mirror-finished. Thereby, the side face 55c of the first support substrate 55 functions as a first reflective surface. Similarly, in a case where the second support substrate 56 is made of a metal having high reflectance, the second reflective layer 28 may not necessarily be provided. In this case, it is desirable that the side face 56d of the second support substrate 56 is mirror-finished. Accordingly, the side face 56d of the second support substrate 56 functions as a second reflective surface.

### Effects of second embodiment

Also in the present embodiment, the leakage of the fluorescence Y from the translucent substrate 23 is suppressed by the action of the first reflective surface 27a and the second reflective surface 28a, whereby the same effects as those in the first embodiment, such as the effect that the use efficiency of the fluorescence Y can be increased, are obtained.

In the present embodiment, since the first support substrate 55 and the second support substrate 56 are each formed of a metal having high thermal conductivity, the heat of the wavelength conversion layer 24 is easily transferred to the first support substrate 55 and the second support substrate 56, whereby the heat dissipation of the wavelength conversion layer 24 can be enhanced. This configuration can suppress a decrease in the wavelength conversion efficiency due to a temperature rise of the wavelength conversion layer 24.

### THIRD EMBODIMENT

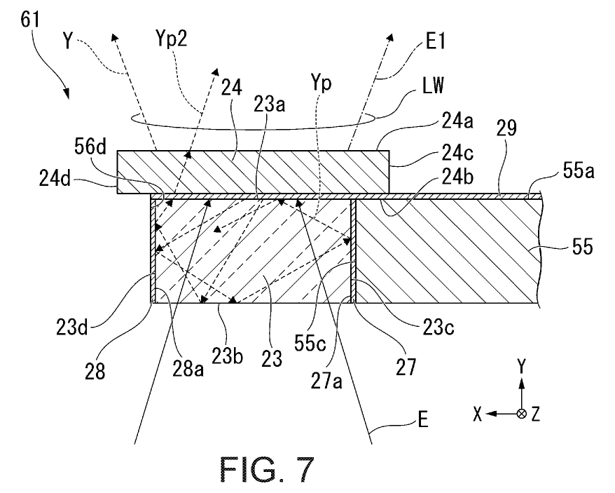

A third embodiment of the present disclosure will be described below with reference to FIG. 7.

The basic configurations of a projector and a light source device according to the third embodiment are substantially the same as those in the first embodiment, and the configuration of the wavelength conversion device is different from that in the first embodiment. Therefore, the description of the basic configuration of the projector and the light source device will be omitted.

FIG. 7 is a cross-sectional view of a wavelength conversion section 61 in a light source device according to a third embodiment.

In FIG. 7, the same reference numerals are given to the same components as those in FIG. 6 used in the second embodiment, and the description thereof will be omitted.

The wavelength conversion section 61 in the present embodiment is formed of the translucent substrate 23, the wavelength conversion layer 24, the first support substrate 55, the first reflective layer 27, the second reflective layer 28, and the dichroic layer 29, as shown in FIG. 7. The wavelength conversion section 61 in the present embodiment has a configuration obtained by omitting the second support substrate 56 from the wavelength conversion section 51 in the second embodiment. The first support substrate 55 is made of a metal having high thermal conductivity such as aluminum or copper, as in the second embodiment. The first reflective layer 27 is provided between the first side 23c of the translucent substrate 23 and the side face 55c of the first support substrate 55. The second reflective layer 28 is provided on the second side 23d of the translucent substrate 23.

The other configurations of the light source device are substantially the same as those of the light source device according to the first embodiment.

### Effects of third embodiment

Also in the present embodiment, the leakage of the fluorescence Y from the translucent substrate 23 is suppressed by the action of the first reflective surface 27a and the second reflective surface 28a, whereby the same effects as those in the first embodiment, such as the effect that the use efficiency of the fluorescence Y can be increased, are obtained.

In the case of the present embodiment, since the second support substrate 56 of the second embodiment is not necessary, the number of components of the light source device can be reduced.

The technical scope of the present disclosure is not limited to the above-described embodiment, and various modifications can be made without departing from the spirit of the present disclosure. In addition, one aspect of the present disclosure can be configured by appropriately combining the characteristic portions of the above-described embodiments.

The light source device of the embodiment described above has both the first reflective surface and the second reflective surface but may have only one of the first reflective surface and the second reflective surface In this case, it is desirable that the light source device has only the first reflective surface. The reason is that, when the first reflective surface is provided, the propagation of the fluorescence to the first support substrate having a larger region than the second support substrate can be suppressed, and the leakage of the fluorescence can be further reduced as compared with the case where only the second support substrate is provided.

In the above embodiment, the first reflective surface and the second reflective surface are provided perpendicular to the first face and the second face of the translucent substrate, respectively, but may be inclined with respect to the first face and the second face of the translucent substrate. That is, the first side and the second side of the translucent substrate may be tapered surfaces. However, as long as the first reflective surface and the second reflective surface are perpendicular to the first face and the second face of the translucent substrate, respectively, the angle of the traveling direction of the fluorescence does not change even when the fluorescence is reflected a plurality of times by each of the reflection surfaces. Therefore, the fluorescence is easily confined inside the translucent substrate, and leakage of the fluorescence can be effectively suppressed.

The light source device according to the present embodiment includes the rotary drive section for rotating the wavelength conversion section but does not necessarily have to include the rotary drive section. That is, the wavelength conversion section including the wavelength conversion layer and the translucent substrate does not necessarily have to be rotatable, and may be fixed. Further, in the embodiments described above, the wavelength conversion layer has an annular shape, but the wavelength conversion layer does not necessarily have to have a continuous annular shape, and may have, for example, a shape that is interrupted in the middle. In this case, the yellow light and the blue light are alternately emitted, and thus it is possible to generate pseudo white illumination light.

In addition, the specific description of the shape, the number, the arrangement, the material, and the like of each component of the light source device and the projector is not limited to the embodiment described above and can be changed as appropriate. Further, in the embodiments described above, there is shown the example in which the light source device according to the present disclosure is mounted on the projector using the liquid crystal panel, but the present disclosure is not limited to this example. The light source device according to the disclosure may be applied to a projector using a digital micromirror device as the light modulation device. The projector may not include a plurality of light modulation devices, and may be a single plate projector including only one light modulation device.

In the embodiments described above, there is shown the example in which the light source device according to the present disclosure is applied to the projector, but the present disclosure is not limited to this example. The light source device of the present disclosure can also be applied to a lighting fixture, a headlight of an automobile, and the like.

### Summary of the present disclosure

Hereinafter, an outline of the present disclosure is appended.

### Appendix 1

The light source device includes

a light source section that emits first light in a first wavelength band;

a wavelength conversion layer that converts the first light into second light in a second wavelength band different from the first wavelength band; and

a translucent substrate including a first face and a second face opposite to the first face, the wavelength conversion layer being arranged on the first face, wherein

the first light emitted from the light source section enters the translucent substrate through the second face, passes through the translucent substrate, and reaches the wavelength conversion layer on the first face,

subsequently, a part of the second light converted by the wavelength conversion layer is emitted toward the translucent substrate through the first face, and

it includes a first reflective surface that intersects the first face and the second face of the translucent substrate and reflects the second light.

According to the configuration of appendix 1, when a part of the second light converted in the wavelength conversion layer enters the translucent substrate, the second light is reflected by the first reflective surface, and thus, the second light is prevented from propagating a long distance inside the light transmissive substrate. This configuration can reduce leakage of the second light from the translucent substrate and increase the efficiency of use of the second light.

### Appendix 2

The light source device according to appendix 1 has the first reflective surface that is perpendicular to both the first face and the second face.

According to the configuration of appendix 2, since the angle of the traveling direction of the second light does not change when the second light is reflected by the first reflective surface, the leakage of the second light can be effectively suppressed.

### Appendix 3

The light source device according to appendix 1 or 2, which has the first reflective surface is provided at a position that overlaps with the wavelength conversion layer when viewed from a direction perpendicular to the first face.

According to the configuration of appendix 3, the second light propagating through the translucent substrate is likely to reenter the wavelength conversion layer, and the second light can be efficiently emitted from the wavelength conversion layer.

### Appendix 4

The light source device according to any one of appendices 1 to 3 further includes

a first support substrate that supports the translucent substrate, wherein

the first support substrate is rotatable about a rotation shaft extending in a normal line direction of the first face and

The first reflective surface is provided at an interface between the translucent substrate and the first support substrate.

According to the configuration of appendix 4, the position of incidence of the first light on the wavelength conversion layer can be moved over time by rotating the first support substrate. This makes it possible to suppress a decrease in wavelength conversion efficiency due to a temperature rise of the wavelength conversion layer.

### Appendix 5

The light source device according to appendix 4 includes the first support substrate that is made of a metal.

With the configuration of Appendix 5, the use of a metal having high thermal conductivity can efficiently suppress the temperature rise of the wavelength conversion layer. Further, by using a metal having a high reflectance, the reflective layer can be made unnecessary.

### Appendix 6

The light source device according to appendix 4 includes the first support substrate, the first support substrate is made of the same material as the translucent substrate

The configuration of the appendix 6 facilitates transfer of heat generated in the wavelength conversion layer from the translucent substrate to the first support substrate and can suppress a decrease in wavelength conversion efficiency.

### Appendix 7

The light source device according to any one of appendices 4 to 6, further includes a second reflective surface that is provided on the surface of the translucent substrate opposite the interface and that reflects the second light.

According to the configuration of appendix 7, the second light incident on the translucent substrate can be confined in the region between the first reflective surface and the second reflective surface, and the leakage of the second light can be more effectively suppressed.

### Appendix 8

The light source device according to appendix 7 includes the second reflective surface, wherein the second reflective surface is perpendicular to both the first face and the second face.

According to the configuration of appendix 8, when the second light is reflected by the second reflective surface, the angle of the propagation direction of the second light does not change, so that leakage of the second light can be effectively suppressed.

### Appendix 9

The light source device according to appendix 7 or appendix 8 includes the second reflective surface, wherein the second reflective surface is provided at a position overlapping the wavelength conversion layer when viewed from a direction perpendicular to the first face.

According to the configuration of appendix 9, the second light propagating through the translucent substrate is likely to reenter the wavelength conversion layer, and the second light can be efficiently emitted from the wavelength conversion layer.

### Appendix 10

The light source device according to appendix 9 further includes

a second support substrate that is provided on a side of the translucent substrate opposite to the first support substrate and supports the translucent substrate.

The second reflective surface is provided at an interface between the translucent substrate and the second support substrate.

According to the configuration of appendix 10, the second reflective surface can be reliably formed between the translucent substrate and the second support substrate.

### Appendix 11

The light source device according to any one of appendices 7 to 10 includes the first reflective surface and the second reflective surface. Each of the first reflective surface and the second reflective surface is formed of a reflective layer comprising any one of a dielectric multilayer film, a metal film, or an adhesive layer containing metal.

According to the configuration of appendix 11, a reflection surface having excellent reflectance can be formed.

### Appendix 12

The light source device according to any one of appendices 1 to 11 further includes a dichroic layer provided between the first face of the translucent substrate and the wavelength conversion layer, that transmits the first light, and that reflects the second light.

According to the configuration of appendix 12, the first light emitted from the light source section can be incident on the wavelength conversion layer, and the incidence of the second light generated in the wavelength conversion layer on the translucent substrate can be suppressed as much as possible, whereby the amount of the second light emitted from the wavelength conversion layer can be ensured.

### Appendix 13

A projector includes

the light source device according to any one of appendices 1 to 12;

a light modulation device that modulates light emitted from the light source device in accordance with image information; and

A projection optical device that projects light modulated by the light modulation device.

According to the configuration of the appendix 13, it is possible to realize the projector capable of projecting the bright image.

What is claimed is:

1. A light source device comprising:
a light source section that emits first light in a first wavelength band;
a wavelength conversion layer that converts the first light into second light in a second wavelength band different from the first wavelength band; and
a translucent substrate including a first face and a second face opposite to the first face, the wavelength conversion layer being arranged on the first face, wherein
the first light emitted from the light source section enters the translucent substrate through the second face, passes through the translucent substrate, and reaches the wavelength conversion layer on the first face,
subsequently, a part of the second light converted by the wavelength conversion layer is emitted toward the translucent substrate through the first face, and
it includes a first reflective surface that intersects the first face and the second face of the translucent substrate and reflects the second light.

2. The light source device according to claim 1, wherein
the first reflective surface is perpendicular to both the first face and the second face.

3. The light source device according to claim 1, wherein
the first reflective surface is provided at a position that overlaps with the wavelength conversion layer when viewed from a direction perpendicular to the first face.

4. The light source device according to claim 1, further comprising:
a first support substrate that supports the translucent substrate, wherein
the first support substrate is rotatable about a rotation shaft extending in a normal line direction of the first face and
the first reflective surface is provided at an interface between the translucent substrate and the first support substrate.

5. The light source device according to claim 4, wherein
the first support substrate is made of metal.

6. The light source device according to claim 4, wherein
the first support substrate is made of the same material as the translucent substrate.

7. The light source device according to claim 4, further comprising:
a second reflective surface that is provided on the surface of the translucent substrate opposite the interface and that reflects the second light.

8. The light source device according to claim 7, wherein
the second reflective surface is perpendicular to both the first face and the second face.

9. The light source device according to claim 7, wherein
the second reflective surface is provided at a position overlapping the wavelength conversion layer when viewed from a direction perpendicular to the first face.

10. The light source device according to claim 9, further comprising:
a second support substrate that is provided on a side of the translucent substrate opposite the first support substrate and that supports the translucent substrate, wherein
the second reflective surface is provided at an interface between the translucent substrate and the second support substrate.

11. The light source device according to claim 7, wherein
each of the first and second reflective surfaces is formed of a reflective layer comprising any one of a dielectric multilayer film, a metal film, or an adhesive layer containing metal.

12. The light source device according to claim 1, further comprising:
a dichroic layer that is provided between the first face of the translucent substrate and the wavelength conversion layer, that transmits the first light, and that reflects the second light.

13. A projector comprising:
the light source device according to claim 1;
a light modulation device that modulates light emitted from the light source device in accordance with image information; and
a projection optical device that projects light modulated by the light modulation device.
